(19) United States
(12) Patent Application Publication
(10) Pub. No.: US 2024/0202749 A1
(43) Pub. Date: Jun. 20, 2024

(54) SYSTEMS AND METHODS FOR ADVANCED TARGETING IN FORECASTING

(71) Applicant: WIDEORBIT LLC, San Francisco, CA (US)

(72) Inventors: Armen Hovhannisyan, Redmond, WA (US); John C. Emery, Oro Valley, AZ (US); Mihail Marchenko, Lake Stevens, WA (US)

(21) Appl. No.: 18/067,551

(22) Filed: Dec. 16, 2022

(51) Int. Cl. G06Q 30/0202; G06Q 30/0242; G06Q 30/0251

(52) U.S. Cl. CPC G06Q 30/0202; G06Q 30/0242; G06Q 30/0271

(57) ABSTRACT

Systems, methods, and articles for generating predictions of the number of impressions received by content, such as advertisements, and the advanced targeting of such content based on the predictions are described herein. The systems disclosed herein predict the number of impressions that content may receive when placed in an advertisement placement opportunities based on user segments used to describe audience members which consume media content. This is achieved by creating an impression prediction model which includes definitions of user segments, data describing audience members which may consume content, historical data describing the impression received by the content, and historical data describing the impressions provided by audience members. When generating predictions for the number of impressions received by content, the system may take into account other content compete with the content for which predictions are generated.

### BACKGROUND

### Technical Field

The present disclosure relates the field of computer technology, and more particularly, to computer systems and methods that facilitate the delivery of content to consumers.

### Description of the Related Art

Content providers such as radio stations and networks, television stations and networks, and Webcasters provide programming including content which is the subject of programming. Content providers' delivery of content is often via broadcasts or Webcasts (collectively, “mediacasts”). While content providers may employ repeaters and the like, broadcasts are typically limited in range to a geographic region.

Programming often includes advertisements interspersed with the subject matter of the programming. The advertisements may occur in segments or slots sometimes referred to as “ad breaks.” Content providers typically sell advertising time to generate revenue to fund operation, as well as generate profits, where the content provider is a commercial entity rather than a nonprofit entity. Advertisers typically offer to buy this advertising time to advertise their products or services. For example, Advertiser A may offer Content Provider B $1000 to buy advertisement time played during Television Show C.

New approaches that automate the various activities related to buying, selling and placement of new materials, for instance, advertisements, in mediacasts are desirable.

### BRIEF SUMMARY

A method of operating a computer system to predict the number of impressions media content will receive may be summarized as including receiving a plurality of sets of audience information from a plurality of audience information providers, each set of audience information including information describing a plurality of audience members, wherein information describing at least a portion of the audience members appears in at least two sets of the plurality of sets of audience information; identifying a plurality of user segments used by each audience information provider of the plurality of audience information providers; receiving audience member historical impression data for each audience member included in each set of audience information of the plurality of sets of audience information; receiving historical media content provider impression data for each media content provider of a plurality of media content providers, the historical media content provider impression data including data indicating a number of impressions received for media content provided by the media content provider; generating, based on at least the plurality of sets of audience information, the plurality of user segments, the audience member historical impression data, and the historical media content provider data, an impression prediction model operative to predict the number of impressions which will be received for an advertisement; receiving an indication of an advertisement which is able to be assigned to air during a particular advertisement placement opportunity associated with a media content provider of the plurality of media content providers, the indication of the advertisement including an indication of the total number of impressions available for the advertisement and targeting criteria for the advertisement; and generating a prediction of the number of impressions that will be received for the advertisement based on the indication of the advertisement, and the generated impression prediction model.

Generating the impression prediction model may further include identifying user profile data for each respective audience member included in each set of audience information by identifying, based on the audience member historical impression data and the information describing the respective audience member, an indication of: at least one network address associated with a computing device associated with the respective audience member, at least one media content provider which provided media content to the computing device associated with the respective audience member, at least one time that the at least one media content provider provided media content, and for each time that the at least one media content provider provided media content, a number of impressions; and generating, based on the identified user profile data, a user profile data table.

A user profile data table may be generated by aggregating the user segments of the plurality of user segments to generate a plurality of aggregated user segments; and for each respective audience member included in the plurality of sets of audience information: determining which user segments of the plurality of aggregated user segments apply to the respective audience member; and adjusting the user profile data for the respective audience member based on the determination of which user segments apply to the respective audience member.

Generating a user profile data table may include determining, based on the historical media content provider impression data, a total number of impressions received for media content provided by each media content provider of the plurality of media content providers; and for each respective audience member included in the plurality of sets of audience information: determining a time of day that the media content was provided to the audience member; determining a time period within which the media content was provided to the audience member; determining a respective media content provider which provided the media content to the audience member; determining, based on the time of day, the time period, the media content provider, and the total number of impressions, the number of impressions provided by the audience member; and adjusting the user profile data for the audience member based on the determination of the number of impressions provided by the audience member.

Generating a prediction may include taking accounting for competing advertisements, such as by receiving an indication of one or more competing advertisements which are also able to be assigned to air during the advertisement placement opportunity, the indication of one or more competing advertisements including targeting criteria for each competing advertisement; and generating the prediction of the number of impressions that will be received for the advertisement based on the indication of the advertisement, the generated impression prediction model, the user profile table, and the indication of the one or more competing advertisements.

A user segment may include one or more attributes, such as an age of the user, an occupation of the user, an income level of the user, or an indication of behavioral information regarding the user.

The method may further include assigning the advertisement to an advertisement placement opportunity based on the predicted number of impressions for the advertisement.

The media content provider impression data may include information indicating at least one date and at least one time that impressions are received for the media content provided by the media content provider.

Generating a prediction may further include receiving an indication of one or more competing advertisements which are also able to be assigned to air during the time that the advertisement placement opportunity occurs, the indication of one or more competing advertisements including targeting criteria for each competing advertisement; and generating the prediction of the number of impressions received for the advertisement based on the indication of the advertisement, the generated impression prediction model and the indication of the one or more competing advertisements.

An indication of one or more competing advertisements may include one or more compete codes for each competing advertisement. An indication of one or more competing advertisements may include one or more frequency caps for each competing advertisement.

An indication of an advertisement may include a priority measure for the advertisement. An indication of one or more competing advertisements may include a priority measure for at least a portion of the competing advertisements. Generating a prediction may further include determining which competing advertisements of the one or more competing advertisements have a priority measure which is the same as the priority measure for the advertisement; and based on the determining, generating the prediction of the number of impressions received for the advertisement based on the indication of the advertisement, the generated impression prediction model, and the determined competing advertisements which have a have a priority measure which is the same as the priority measure for the advertisement.

The method may further include receiving an indication of one or more additional advertisement placement opportunities associated with one or more media content providers of the plurality of media content providers; generating additional predictions of the number of impressions received for the advertisement for each of the one or more additional advertisement placement opportunities based on the indication of the advertisement, the generated impression prediction model, and the indication of the one or more additional advertisement placement opportunities; and based on at least the prediction of the number of impression received for the advertisement and the additional predictions of the number of impressions received for the advertisement, augmenting one or more parameters of a campaign for the advertisement.

The method may further include receiving an indication of an advertisement campaign, the indication of the advertisement campaign including an indication of a plurality of advertisements, each respective advertisement of the plurality of advertisements being assigned to an advertisement placement opportunity, each respective advertisement further including targeting criteria for the respective advertisement, wherein the plurality of advertisements includes the advertisement; and for each respective advertisement included in the advertisement campaign: generating an additional prediction of the number of impressions that will be received for the advertisement based on the indication of the respective advertisement, and the generated impression prediction model for the respective advertisement.

The method may further include aggregating the predictions of the number of impressions received for each respective advertisement in the advertisement campaign; and generating a prediction of the total number of impression that will be received for the advertisement campaign based on the aggregated predictions.

The targeting criteria may include at least one of: one or more dayparts, one or more device types, one or more media content providers, one or more geographic area, one or more user attributes, or one or more seasons.

Generating the prediction may be performed in near-real-time.

A system used to predict the number of impressions media content will receive may comprise: at least one processor; and at least one memory coupled to the at least one processor, the at least one memory having computer-executable instructions stored thereon that, when executed by the at least one processor, cause the system to: receive a plurality of sets of audience information from a plurality of audience information providers, each set of audience information including information describing a plurality of audience members, wherein information describing at least a portion of the audience members appears in at least two sets of the plurality of sets of audience information; identify a plurality of user segments used by each audience information provider of the plurality of audience information providers; receive audience member historical impression data for each audience member included in each set of audience information of the plurality of sets of audience information; receive historical media content provider impression data for each media content provider of a plurality of media content providers, the historical media content provider impression data including data indicating a number of impressions received for media content provided by the media content provider; generate, based on at least the plurality of sets of audience information, the plurality of user segments, the audience member historical impression data, and the historical media content provider data, an impression prediction model operative to predict the number of impressions which will be received for an advertisement; receive an indication of an advertisement which is able to be assigned to air during a particular advertisement placement opportunity associated with a media content provider of the plurality of media content providers, the indication of the advertisement including an indication of the total number of impressions available for the advertisement and targeting criteria for the advertisement; and generate a prediction of the number of impressions that will be received for the advertisement based on the indication of the advertisement, and the generated impression prediction model.

A nontransitory processor-readable storage medium may store at least one of instructions or data, the instructions or data, when executed by at least one processor, may cause the at least one processor to: receive a plurality of sets of audience information from a plurality of audience information providers, each set of audience information including information describing a plurality of audience members, wherein information describing at least a portion of the audience members appears in at least two sets of the plurality of sets of audience information; identify a plurality of user segments used by each audience information provider of the plurality of audience information providers; receive audience member historical impression data for each audience member included in each set of audience information of the plurality of sets of audience information; receive historical media content provider impression data for each media content provider of a plurality of media content providers, the historical media content provider impression data including data indicating a number of impressions received for media content provided by the media content provider; generate, based on at least the plurality of sets of audience information, the plurality of user segments, the audience member historical impression data, and the historical media content provider data, an impression prediction model operative to predict the number of impressions which will be received for an advertisement; receive an indication of an advertisement which is able to be assigned to air during a particular advertisement placement opportunity associated with a media content provider of the plurality of media content providers, the indication of the advertisement including an indication of the total number of impressions available for the advertisement and targeting criteria for the advertisement; and generate a prediction of the number of impressions that will be received for the advertisement based on the indication of the advertisement, and the generated impression prediction model.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 shows an example networked environment according to one illustrated implementation in which various apparatus, methods and articles described herein may operate.

FIG. 2 is a block diagram showing sample elements of an advanced targeting system, according to one illustrated implementation.

FIG. 3 is a table diagram depicting an example user inventory profile table, according to one illustrated implementation.

FIG. 4 is a flow diagram of a process for generating a prediction of the number of impressions that will be received from the advertisement, according to one illustrated implementation.

FIG. 5 is a flow diagram of a process for generating a user inventory profile data table, according to one illustrated implementation.

FIG. 6 is a flow diagram of a process for assigning aggregated user segments to audience members, according to one illustrated implementation.

FIG. 7 is a flow diagram of a process for determining an inventory ratio for each audience member, according to one illustrated implementation.

FIG. 8 is a flow diagram of a process for generating prediction of the number of impressions that will be received for an advertisement based on an indication of one or more competing advertisements, according to one illustrated implementation.

FIG. 9 is a sample competing advertisement table, according to one illustrated implementation.

FIG. 10 is a flow diagram of a process for generating a campaign for an advertisement, according to one illustrated implementation.

FIG. 11 is a flow diagram of a process to predict the number of impressions received by a campaign, according to one illustrated implementation.

FIG. 12 shows a processor-based device 1204 suitable for implementing the various functionality described herein.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to computer-implemented systems and methods of automating and optimizing the buying and selling of advertisements, or “spots.” Buying and selling television, radio or digital advertising has traditionally been a highly manual process and requires many participants to execute orders. Layering in audience and pricing data adds another level of complexity to the campaign execution workflow.

In conventional workflows, an advertiser, or “buyer”, contacts multiple networks, or “media content providers,” to negotiate and purchase spots. The advertiser may negotiate a price with each of these providers, only to find out later on that one or more of the media content providers have rejected their offers, resulting in wasted time, effort, and, in the case of negotiations and purchases that use computer systems or automation, computer resources. An advertisement is “cleared” when a buyer's offer to buy a spot is accepted by a seller, or media content provider and the buyer's advertisement is published in the spot.

An aspect in the negotiation for the price of each spot is the number of “impressions” that each spot may have. An impression is a numerical measure of the number of people who are likely to encounter the advertisement. The audience members associated with the impressions for a spot may each have certain attributes which may correspond to a “segment” or “user segment.” An audience member may have multiple user segments, and an advertiser may desire to have impressions from particular user segments, a variety of user segments, etc. An advertiser may target specific user segments, rather than the entirety of the spot inventory, in order to ensure that the advertisement reaches the intended audience members. The attributes that may be included in the user segments may include one or more of: an age of the audience member; an occupation of the audience member; an income level of the audience member; an indication of behavioral information regarding the audience member; an indication of one or more items, products, or other objects owned by the audience member; an indication of one or more services consumed, accessed, or otherwise used by the audience member; an indication of the composition of the household of the audience member; and any other attribute which may describe an audience member.

The user segments for each audience member are obtained from multiple sources. Thus, these segments typically overlap and contain redundant information, such as, for example, multiple segments that cover the same age and gender, but have overlapping age ranges. Each user segment may also be mapped to a specific user via an identifier, such as a network address for devices associated with the user, a unique identifier for the user, or other methods of identifying a user. Furthermore, audience member demographics and behaviors change for a spot based on a variety of considerations, such as daypart, station, geography, the device playing the content, or other considerations which alter or change audience member demographics or behaviors.

Because of the vast amount of data regarding user segments, the overlapping data regarding such segments, and the variety of considerations, conventional systems are unable to accurately predict the number of impressions that a spot may receive for specific user segments. Furthermore, attempts by conventional systems to make such predictions are resource-intensive to the point where it is infeasible to account for all of the data when making the prediction.

With presently available systems, it is not possible to obtain accurate predictions of the number of impressions content may receive based on user segments without consuming vast amounts of computing resources, such as memory, data storage, processing power, etc. Additionally, presently available systems include inconsistent user segments which may overlap with other user segments. Such user segments included in present systems cause the presently available systems to use more data storage space due to the presence of redundant data. Furthermore, the redundant user segments cause presently available systems to require additional processing resources in order to obtain predictions of the number of impressions content may receive based on the user segments.

Implementations of the present disclosure are directed to computer-implemented systems and methods for predicting the number of impressions that will be received for an advertisement based on user segments from a variety of sources and considerations regarding the behavior and demographics of an audience. Thus, the aforementioned inefficient and unreliable processes are improved to provide predictions of the number impressions an advertisement may receive in a more efficient manner which takes into account all of the relevant data while preserving computing resources.

Such implementations are thus able to improve the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by aggregating overlapping segments, implementations of the present disclosure are able to reduce the amount of data needed to make an accurate prediction. This reduction in the volume of data leads to fewer data-storage devices for storing the data and fewer computer resources used in processing the data due, thus allowing the implementations of the present disclosure to improve the operation of computing devices which are used to predict the number of impressions an advertisement may receive.

In at least some implementations, buyers and sellers can trade mediacast (e.g., broadcast, Webcast) advertisement inventory (e.g., direct or programmatically) at local, national, and/or worldwide levels. The types of media traded via may simultaneously include numerous types of media, including TV, cable, satellite, radio, outdoor, display, digital, print, etc. Such programmatic advertising implements data-driven automation of audience-based advertising operations which inverts the industry standard in which marketers rely on show ratings to determine desirable audiences for the marketers' advertisements.

In at least some implementations, the advanced targeting system disclosed herein interfaces with demand side platforms (DSPs) that assist buyers in making offers to sellers. Sellers enjoy seamless transaction workflow for getting advertisements from proposal, to publishing, and to billing that delivers a significant reduction in time spent on reconciliation and “make-goods” and streamlines processes for creative management and revenue management across direct and programmatic sales channels. The advertiser-facing interface facilitates creative placement and reviewing for the buy side, and may have transcoding and approval tools for the sell side. For example, in some implementations, once an advertisement transaction is approved, the advertiser-facing interface sends the advertisement directly to a broadcaster's traffic system.

In some implementations, the cross provider content assignment systems disclosed herein automate aspects of billing, reconciliation, and creative execution. In some implementations, the cross provider content assignment systems may be integrated with advertisement management software and sales and traffic management systems.

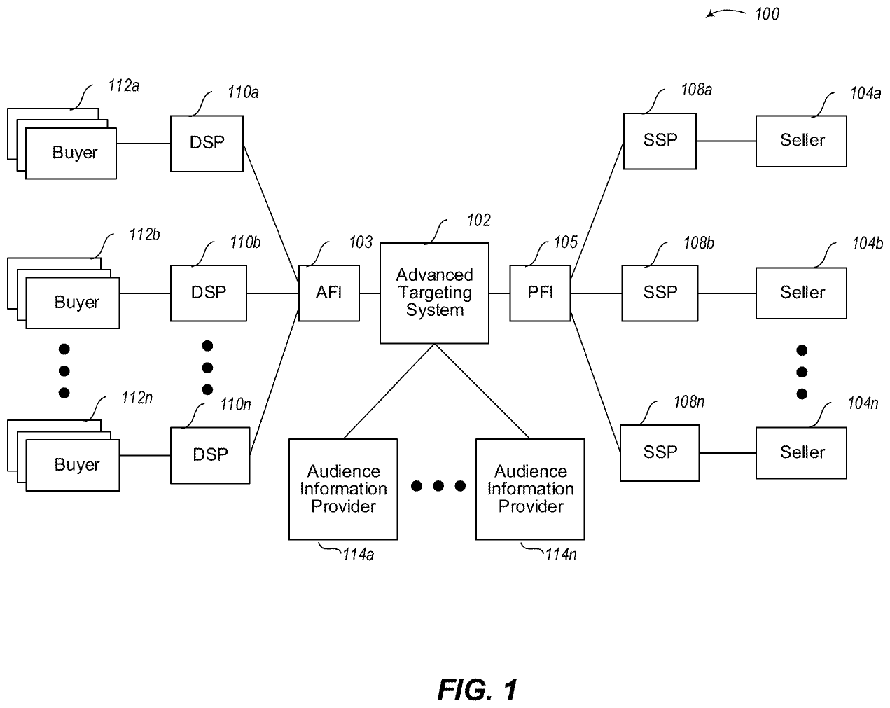

FIG. 1 shows an example networked environment 100 according to one illustrated implementation in which various apparatus, methods and articles described herein may operate. The environment 100 includes an advanced targeting system 102, an advertiser-facing interface (AFI) 103, a media content provider-facing interface (PFI), a number of sellers or content providers 104A-104N (collectively 104), a number of seller side platforms (SSPs) 108A-108N (collectively 108), a number of demand side platforms (DSPs) 110A-110N (collectively 110), a number of buyers 112A-112N (collectively 112), such as advertisers or agencies, and a number of audience information providers 114A-114N (collectively 114), all communicatively coupled by one or more networks or other communications channels. The audience information providers 114 may be entities which collect audience information for audiences who view media content, such as media content provided by one of the content providers 104. The various components of the environment may be distributed or integrated in any number of ways. For example, in at least some implementations, two or more of the DSPs 110, AFI 103, clearance optimizer system 102, and PFI 105 may be integrated into a single platform provided by one or more entities. In some embodiments, the DSP's 110 are not included in the environment 100.

The sellers 104 may take a variety of forms, for example, radio stations or broadcasters, television stations or broadcasters, other terrestrial or satellite broadcasters or multicasters (not shown), Webcasters, printed content (e.g., print media) providers, outdoor content (e.g., billboards) providers, etc. The sellers 104 may, or may not, own the content that they provide. The sellers 104 utilize the PFI 105 to access the clearance optimizer system 102. On the buy side, the buyers 112 (e.g., advertisers, agencies) may interface with the system 102 via the AFI 103 through the buyers' respective DSPs 110.

In an example implementation, a buyer 112a may request a prediction of the number of impressions that are based on user segments for one or more advertisements or advertisement placement opportunities. A buyer 112 may make such a request when they are attempting to “target” specific user segments, such that their advertisement is more likely to appear to users which belong to one or more user segments. This type of “targeting” may be referred to as “advanced targeting.”

In the example implementation, the advanced targeting system, such as the advanced targeting system 102, aggregates audience information from a variety of audience information providers, such as the audience information providers 114. The audience information includes historical impression data for each audience member and user segments used by each audience information provider 114. This data is combined with historical media content provider impression data, which is obtained from the various media content providers 104, to create an impression prediction model. The impression prediction model is able to predict the number of impressions, as well as information describing each audience member providing the impressions, that an advertisement assigned to air during a particular advertisement placement opportunity will receive. The prediction of the number of impressions may be used to place the advertisement in an advertisement placement opportunity based on criteria specified by buyer 112a.

In another example implementation, multiple buyers 112 may request that their advertisements are allocated based on advanced targeting. The advanced targeting system may take into account each advertisement associated with each of the buyers when generating the prediction of the number of impressions that each advertisement will receive. Furthermore, the advanced targeting system may identify the number of impressions each advertisement will receive at the audience member level, such that each audience member which may see the advertisement is accounted for when predicting the number of impressions that each advertisement will receive. The advanced targeting system is further able to determine how many impressions of the total number of impressions available during the time that an advertisement placement opportunity takes place will be allocated to each advertisement.

As the number of buyers, advertisements, advertisement placement opportunities, audience members, user segments etc., increase, the complexity of the prediction increases exponentially, such that it becomes impossible for a human to manually predict the number of impressions that an advertisement may receive on the user segment level (that is, when the buyer wishes to perform advanced targeting of their advertisement).

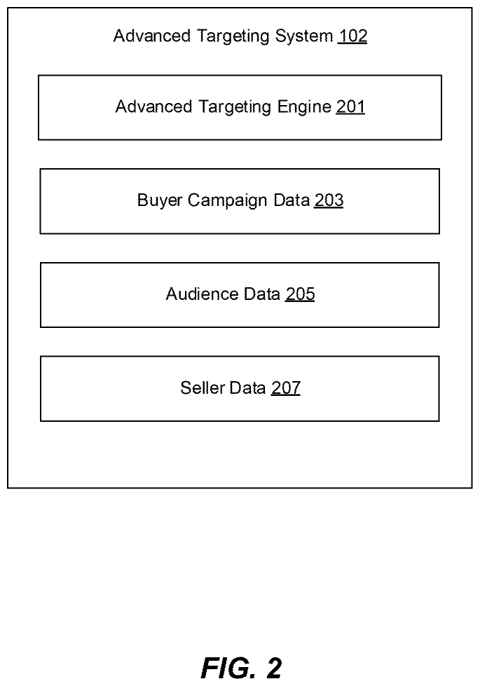

FIG. 2 is a block diagram showing sample elements of an advanced targeting system 102, according to one illustrated implementation. The advanced targeting system 102 includes an advanced targeting engine 201, buyer campaign data 203, audience data 205, and seller data 207. The advanced targeting engine 201 collects and analyzes audience data 205 received from one or more audience information providers, such as the audience information providers 114. The advanced targeting engine 201 uses the audience data 205 along with seller data 207 and buyer data 203 to generate an impression prediction model which can be used to predict the number of impressions an advertisement will receive. The advanced targeting engine 201 may use one or more of the table 300, process 400, process 500, process 600, process 700, process 800, table 900, process 1000, and process 1100 to perform the operations described herein. Furthermore, the advanced targeting engine 201 may perform the operations described herein in near-real-time.

The buyer campaign data 203 includes data related to advertising campaigns and individual advertisements, such as attributes for the campaign, attributes for the advertisement (or “advertisement placement attributes”), or other data related to advertisements and advertisement campaigns, defined by the buyer. The data may include, for example: goals for a campaign, such as a target number of impressions, a budget, advertising across a wide variety of media content, a CPM goal, etc.; advertisement attributes for one or more advertisements, such as a target demographic, target number of impressions, a budget for the advertisements, preferred days, preferred day parts, excluded media content, excluded media content providers, and other attributes used to describe an offer for an advertisement spot; a target audience, or audiences; and other data describing the buyer or its requirements, goals, etc. In some implementations, the buyer campaigns data is obtain through an AFI 103.

The seller data 207 includes data related to media content segments, advertisement placement opportunities, such as attributes for media content segments, attributes for advertisement placement opportunities, attributes for a media content provider, etc., and other data related to the seller. The seller data may include, for example: media content provider information, such as capacity for advertisements (such as a measure of the total inventory available), advertisement placement opportunities for each provider, data indicating one or more content segments, such as media content segments, published by the media content provider, and other information related to the media content provider; historical impression data indicating one or more of the number of impressions received for media content provided by the media content provider, the times that the impressions were received, and an indication of an audience member which provided the impression; rates, such as a preferred rate, rate guidance (i.e. a range of rates which the provider would accept), or actual rate, for each advertisement placement opportunity; and other information which may be obtained from, or is related to, a media content provider. In some implementations, a media content segment may have multiple audiences (for example, a media content segment may have an audience made up of people age 20-40 and females age 30-40).

The audience data 205 includes data related to the composition of an audience for media content segments. The audience data 205 may include historical impressions data for audience members, which may include data indicating the number of impressions provided by each audience member, the time that the impressions were provided, the media content to which the impressions were provided, and other data related to impressions provided by audience members. The audience data may additionally include, for example, data describing user segments for each audience member, identifying information for each audience member, such as a network address or other identifier for a device used to access media content, or other data related to audience members. The audience data 205 may be provided by a plurality of audience information providers, such as audience information providers 114. The audience data provided by audience information providers may be formatted in various manners, have various types of user segment definitions, or may be presented or transmitted in other ways, such that the audience data is inconsistent or redundant when initially received from the audience information providers.

The advanced targeting system 102 alters the audience data received from audience information providers to obtain the audience data 205. Such alterations may include one or more of: reducing the number of user segments, such as by aggregating user segments; mapping identifying information for each audience member, such as a network address, to the aggregated user segments; or other methods of altering audience data to reduce inconsistencies or redundant information. For example, an audience member may be identified as “high-income” in one audience information provider, but may be identified as “wealthy” in another audience information providers. In such an example, the user segments for this audience member is inconsistent between the audience information providers, and the user segment identification may also be redundant between the audience information providers. The advanced targeting system 102 may receive the criteria for determining whether an audience member is part of these user segments from each of the audience information providers and may determine whether they are intended to indicate the same attribute. Continuing the example, if “high-income” indicates that the audience member has an income greater than $500,000 and if “wealthy” indicates that the audience member has an income greater than “200,000,” then the advanced targeting system 102 may assign the audience member to an aggregated user segment which more accurately reflects the income of the audience member.

In some embodiments, the advanced targeting system operates as part of a larger system used to assign advertisements to slots within advertisement placement opportunities. This larger system may include interfaces to receive data from both media content providers and advertisers regarding the advertisements which are to be placed, the advertisement placement opportunities, the performance of the advertisement (such as the number of impression received by media content during which the advertisement aired), auctions or other methods used to place advertisements, or other data related to buying, selling, and placing advertisements within advertisement placement opportunities. By operating as a part of this larger system, the advanced targeting system is able to take into account additional data which is not directly available to other conventional systems for targeted advertisements. Furthermore, the advanced targeting system is able to use techniques not available to conventional systems to obtain a prediction of the number of impressions which media content will receive, such as taking into account the other competing advertisements which may be airing at the same time when predicting the number of impressions which may be received by each advertisement.

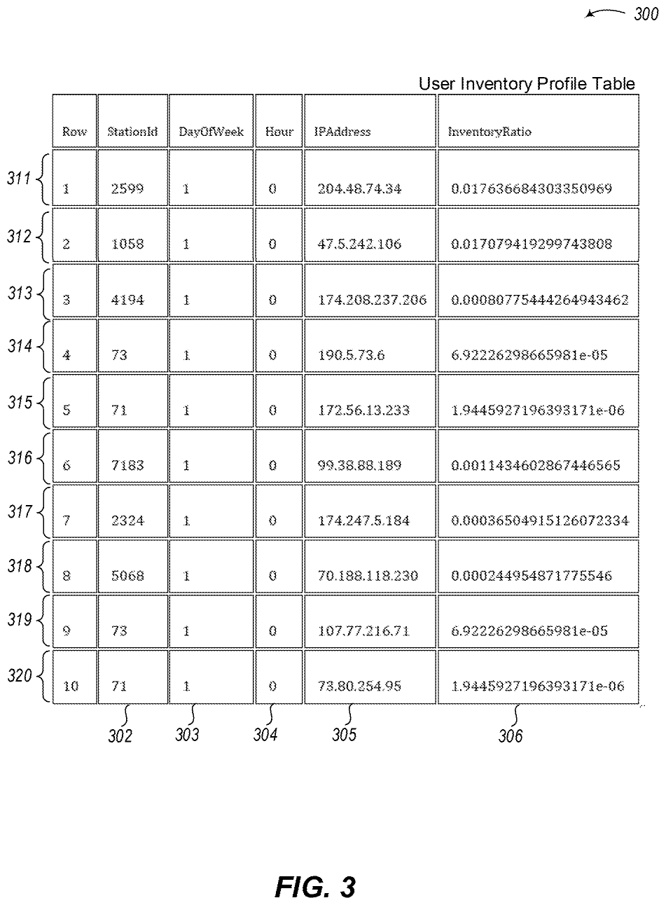

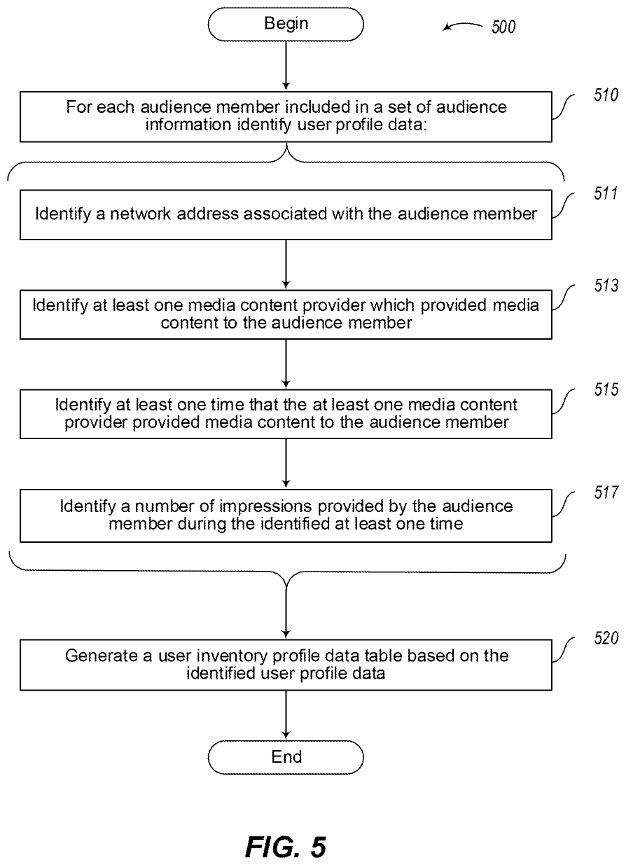

FIG. 3 is a table diagram depicting an example user inventory profile table 300, according to one illustrated implementation. The user inventory profile table 300 includes sample data that is in human-readable form and implementations of the advanced targeting system may include data in other forms. Furthermore, the user inventory profile table 300 is non-exhaustive, and implementations of the advanced targeting system may include additional rows, columns, etc., which are not shown in FIG. 3. All or part of the user inventory profile table 300 may be included in the advanced targeting system 102, for example, as part of the advanced targeting engine 201, included in one or more servers or computing systems external to the advanced targeting system, etc. The user inventory profile table 300 may be used by the advanced targeting system as a record of when impressions are received from particular users (i.e. “audience members”), and to which media content providers those impression were allocated. In some embodiments, the user inventory profile table 300 is generated by using the process 500 described below in connection with FIG. 5.

The user inventory profile table 300 includes multiple columns, such as a station ID column 302, a day of week column 303, an hour column 304, an IP address column 305, and an inventory ratio column 306. The user inventory profile table 300 additionally includes rows 311-320. The station id column 302 includes data indicating a media content provider which provided media content to an audience member. The day of week column 303 includes data indicating a day of the week that an impression was received from the audience member. The hour column 304 includes data indicating an hour of the day at which the impression was received from the audience member. The IP address column 305 includes data indicating an IP address of a device associated with the audience member. The inventory ratio column 306 includes data indicating a ratio of the impressions received from the device associated with the audience member and the total number of impressions that the station has received at the time that the impressions were received from the audience member.

The user inventory profile table 300 additionally includes multiple rows, such as rows 311-320. Each row included in the user inventory profile table 300 indicates data related to the ratio of the number of impressions provided by a device associated with an audience member at a certain time and the media content provider to which the impressions were allocated. For example, row 311 indicates that the station identified as “2599” received impressions from an audience member associated with the IP address “204.48.74.34” at day “1,” hour “0.” The row 311 additionally indicates that the ratio of impressions provided by the user to the total number of impressions received by station “2599” at hour “0” of day “1” was about “0.0176” or 1.76 percent of the total number of impressions.

In an example embodiment, the user inventory profile table 300 includes data describing the impressions received for each station for the previous eight weeks. In the example embodiment, the impressions included in the user inventory profile table 300 are identified based on the station, day of week, and hour. Thus, the user inventory profile table 300 is able to identify which audience member provided impressions based on the daypart that the impressions were received. This data may be further used to identify media content which the audience member viewed. Thus, in the example embodiment, if a station receives one thousand impressions over eight weeks on Thursdays at 10:00 AM, and an audience member generated five impressions over this same period, the inventory ratio of associated with the audience member is 0.005.

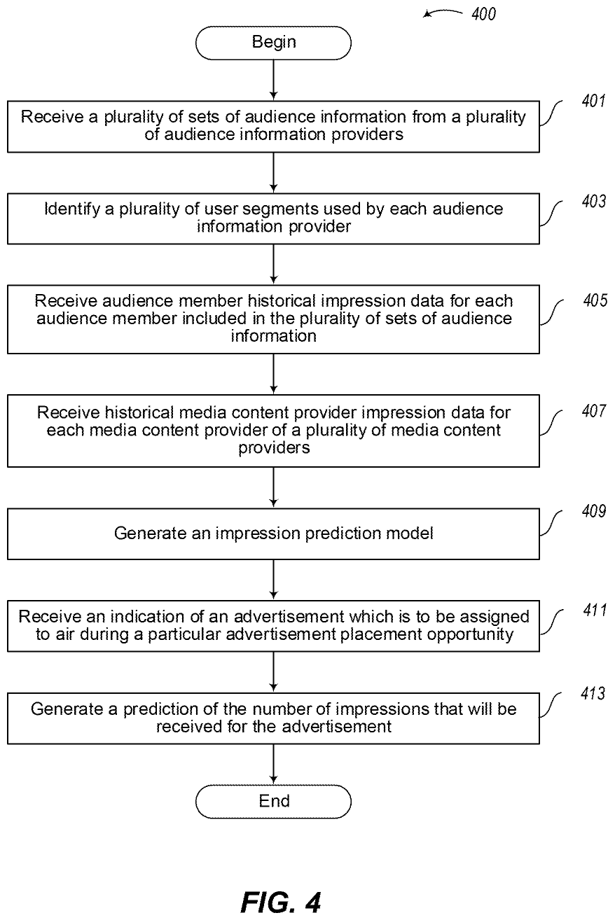

FIG. 4 is a flow diagram of a process 400 for generating a prediction of the number of impressions that will be received from the advertisement, according to one illustrated implementation. The process 400 begins, after a start block, at act 401, where an advanced targeting system, such as the advanced targeting system 102, receives a plurality of sets of audience information from a plurality of audience information providers. In some embodiments, the advanced targeting system processes the audience information to obtain audience data, such as the audience data 205 discussed above with respect to FIG. 2.

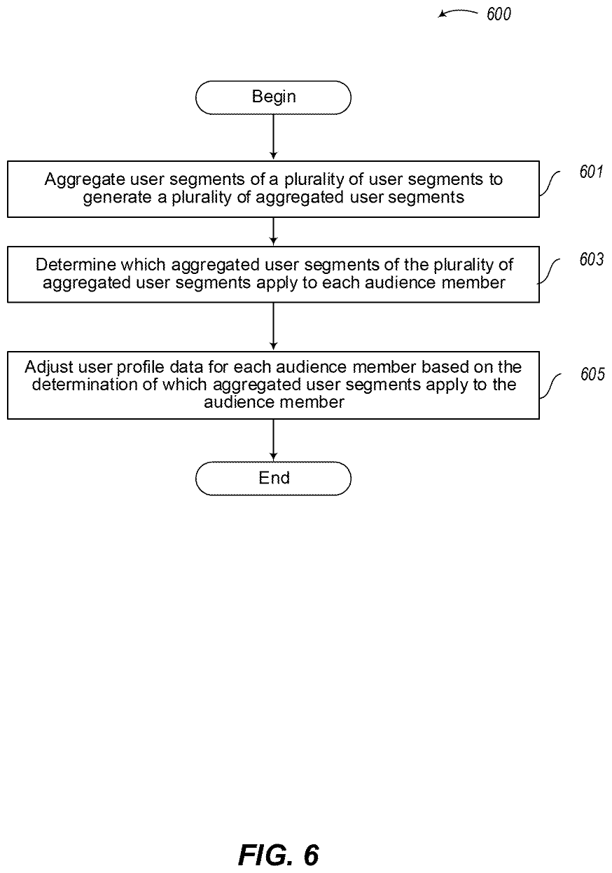

The process 400 continues to act 403, where the advanced targeting system identifies a plurality of user segments used by each audience information provider. In some embodiments, at act 403, the advanced targeting system creates aggregated user segments based on the identified plurality of user segments, and associates each audience member indicated by the audience information with at least one aggregated user segment. In some embodiments, the advanced targeting system performs act 403 by performing the process 600 described below in connection with FIG. 6.

The process 400 continues to act 405, where the advanced targeting system receives audience member historical impression data for each audience member included in the plurality of sets of audience information. In some embodiments, the advanced targeting system receives the audience member historical data from one or more audience information providers. The audience member historical impression data may include data regarding which audience members provided impressions to media content, the time and day that the impression was provided, the media content for which the impression was received, or other data related to impressions provided by audience members. The process 400 continues to act 407, where the advanced targeting system receives historical media content provider impression data for each media content provider of a plurality of media content providers.

The process 400 continues to act 409, where the advanced targeting system generates an impression prediction model. The advanced targeting system may generate the impression prediction model based on one or more of the plurality of user segments, aggregated user segments, audience member historical impression data, and historical media content provider impression data. In some embodiments, as part of generating the impression prediction model, the advanced targeting system generates a user inventory profile table, such as the user inventory profile table 300. The advanced targeting system may use the process described below in connection with FIG. 5 to generate the user inventory profile table. In some embodiments, the impression prediction model includes a multi-dimensional table which includes information related to the user segments and information included in the user inventory profile table. For example, in such embodiments, the multi-dimensional table may be generated by mapping the user segments to the user inventory profile table based on the user segments for each audience member.

In some embodiments, the impression prediction model includes a forecasting model which is applied to the historical impression data. The historical impression data may be broken down into multiple dimensions, such as via user segments (e.g. user segments included in the user inventory profile table 300). The historical impression data may be further aggregated into groups, or “chunks,” of data organized by time period, such as hourly chunks, daily chunks, 30-minute chunks, etc. In some embodiments, the forecasting model includes one or more short term linear regression models, one or more long term linear regression models, one or more artificial intelligence or machine learning models, any other model which may be used to forecast data, or any combination thereof. In embodiments where the forecasting model additionally evaluates the initial values for linear regression models based on weighted moving averages. The weighted moving averages may be determined based on the historical impression data, the chunks of historical impression data, the dimensions of the historical impression data, etc. In an exemplary embodiment, the forecasting model includes a combination of short term linear regression models and long term linear regression models whose initial vales are based on weighted moving averages calculated form the historical impression data.

In some embodiments, the impression prediction model includes seasonality data regarding seasonality, seasonal deviation, etc., of impressions. The seasonality data may be applied to the forecasting model with the historical impression data to allow the impression prediction model to take into account seasonal changes in the impression data.

In some embodiments, one or more machine learning models may be trained based on historical impression data, seasonality data, user segments, or any other data used by the impression prediction model, to predict a number of impressions for a target advertisement. The one or more machine learning models may be included in the forecasting model.

The process 400 continues to act 411, where the advanced targeting system receives an indication of an advertisement which is to be assigned to air during a particular advertisement placement opportunity. The advanced targeting system may receive the indication of the advertisement via user input, such as user input received via an advertiser facing interface (e.g. the AFI 103), a provider facing interface (e.g. the PFI 105), or another user interface.

The process 400 continues to act 413, where the advanced targeting system generates a prediction of the number of impressions that will be received for the advertisement. The advanced targeting system may generate the prediction of the number of impressions that will be received for the advertisement based on the indication of the advertisement and the generated impression prediction model. For example, the advanced targeting system may identify the time, day, and on which media content provider the indicated advertisement is assigned to air, and apply this information to the impression prediction model to obtain the generated prediction.

In some embodiments, at act 413 the impression prediction model is used to forecast the total number of impressions available during a particular day, hour, etc., during which the advertisement is to air. The advanced targeting system may further break down the time period within which the impressions are forecasted based on combinations of core dimensions. The “broken down” time period may be or include at least a portion of the time period during which the advertisement placement opportunity takes place. In some embodiments, the time periods may be broken down into chunks, based on time chunks used for historical impression data. For advertisements which are not targeted based on user segments, the impression prediction model may determine how many other advertisements are scheduled to air during the broken down time period and equally allocate the total number of impressions to each of the advertisements.

In some embodiments, the core dimensions include one or more of: day of the week to air the advertisement; hour in the day to air the advertisement; an indication of the station airing the advertisement; a designated market area for the advertisement; a city, region, country, zip code within which the advertisement airs; a metropolitan statistical area for the advertisement; the client device upon which the advertisement is displayed; the source which provides the advertisement to the client device, such as software or services operating on the client device to provide media content; an impression type for the advertisement, such as whether the impression is internal or from an external advertisement network; an inventory type for the media content, such as whether the media content is provided via a gateway, on demand, streaming, etc.; an advertisement zone, such as whether the advertisement is post roll, mid roll, pre roll, etc.; an advertisement position, such as whether the advertisement is positioned in stream, through a gateway, etc.; an advertisement placement, such as whether the advertisement tis the first advertisement in the break, second advertisement in the break, last advertisement in the break, etc.; the advertisement format, such as whether the advertisement includes audio, video, text, or any combination thereof; and any other dimensions which may be used to classify or otherwise describe an advertisement.

In some embodiments, the indication of the advertisement includes an indication that the advertisement is to be targeted to audience members based on user segments. The indication that the advertisement is to be targeted based on user segments may conclude targeting criteria, such as an indication of at least one of: one or more user segments, one or more media content providers, one or more dayparts, one or more geographic areas, one or more audience member attributes, or one or more seasons. For such advertisements, the impression prediction model determines how many audience members which match the targeting criteria of the advertisement are predicted to provide impressions during the broken down time period. The impression prediction model may use a user inventory profile table, such as the user inventory profile table 300, determine how many audience members which match the targeting criteria are predicted to provide impressions. The impression prediction model may determine a total inventory ratio for the advertisement based on the number of audience members which match the targeting criteria, and may use the total inventory ratio to determine the number of impressions received for the advertisement. For example, if the targeted audience members have a total inventory ratio of 0.40 and the media content provider was predicted to receive 100 impressions in the hour, the predicted number of impressions would be 40.

In some embodiments, the advertisement is an advertisement which is already scheduled to air within an advertisement placement opportunity, and the prediction obtained by the impression prediction model is a prediction of the number of impressions which will be received by the advertisement when the advertisement airs during the advertisement placement opportunity.

After act 413, the process 400 ends.

In some embodiments, the advanced targeting system uses the prediction of the number of impressions which will be received by the advertisement to assign the advertisement to an advertisement placement opportunity. For example, the advanced targeting system may assign the advertisement to an advertisement placement opportunity which is predicted to provide the greatest total number of impressions. As another example, the advanced targeting system may assign the advertisement to an advertisement placement opportunity which is predicted to provide the greatest number of impressions for one or more user segments based on the targeting criteria of the advertisement, rather than the greatest total number of impressions overall. In these examples, the advanced targeting system may assign the advertisement based on one or more goals of the buyer, such as reaching a certain number of audience members, reaching a certain number of audience members belonging to one or more user segments, or other goals a buyer may have for an advertisement.

FIG. 5 is a flow diagram of a process 500 for generating a user inventory profile data table, such as the user inventory profile data table 300, according to one illustrated implementation. The process 500 begins, after a start block, at act 510, where the advanced targeting system identifies user profile data for each audience member included in a set of audience information. To identify the user profile data, the advanced targeting system performs acts 511-517.

At act 511, the advanced targeting system identifies a network address associated with the audience member. The network address may be included in the audience information received from each of the audience information providers.

At act 513, the advanced targeting system identifies at least one media content provider which provided media content to the audience member. The advanced targeting system may identify the at least one media content provider based on information included in one or more of the audience information, historical media content provider impression data, and audience member historical impression data.

At act 515, the advanced targeting system identifies at least one time that the at least one media content provider provided media content to the audience member. The advanced targeting system may identify the at least one time based on information included in one or more of the audience information, historical media content provider impression data, and audience member historical impression data.

At act 517, the advanced targeting system identifies a number of impressions provided by the audience member during the identified at least on time. The advanced targeting system may identify the number of impressions provided by the audience member based on information included in one or more of the audience information, historical media content provider impression data, and audience member historical impression data. In some embodiments, at act 517, the advanced targeting system determines a ratio of the number of impressions provided by the audience member compared to the total number of impressions received by the media content provider, such as the inventory ratio discussed above in connection with FIG. 3.

After act 510, the process proceeds to act 520. At act 520, the advanced targeting system generates a user inventory profile data table based on the user profile data identified for each audience member.

After act 520, the process 500 ends.

FIG. 6 is a flow diagram of a process 600 for assigning aggregated user segments to audience members, according to one illustrated implementation. The process 600 begins, after a start block, at act 601, where the advanced targeting system aggregates user segments of a plurality of user segments to generate a plurality of aggregated user segments. In some embodiments, aggregating the user segments includes identifying the criteria for each user segment of the plurality of user segments and determining whether any of the criteria for at least one user segment overlaps with the criteria of at least one other user segment. In such embodiments, the amount of overlap in criteria for the user segments indicates how similar the user segments are to each other. The user segments may be aggregated based on their similarity to one another.

The process 600 continues to act 603, where the advanced targeting system determines which aggregated user segments of the plurality of aggregated user segments apply to each audience member. In some embodiments, the advanced targeting system determines which aggregated user segments apply to each audience member based on one or more of: the criteria for the original user segments, the criteria for the aggregated user segments, and data describing each audience member. In such embodiments, the advanced targeting system may identify user segments which were associated with an audience member and use that information to determine whether an aggregated user segment should be associated with the audience member. For example, the advanced targeting system may identify that a user was included in a user segment for commuters and another user segment for automobile owners. The advanced targeting system may then determine that the audience member uses their automobile for commuting and determine that the audience member belongs in a user segment for commuters who commute via automobile.

The process continues to act 605, where the advanced targeting system adjusts user profile data for each audience member based on the determination of which aggregated user segments apply to the audience member. The advanced targeting system may adjust the user profile data to include the aggregated user segments which apply to the audience member.

After act 605, the process 600 ends.

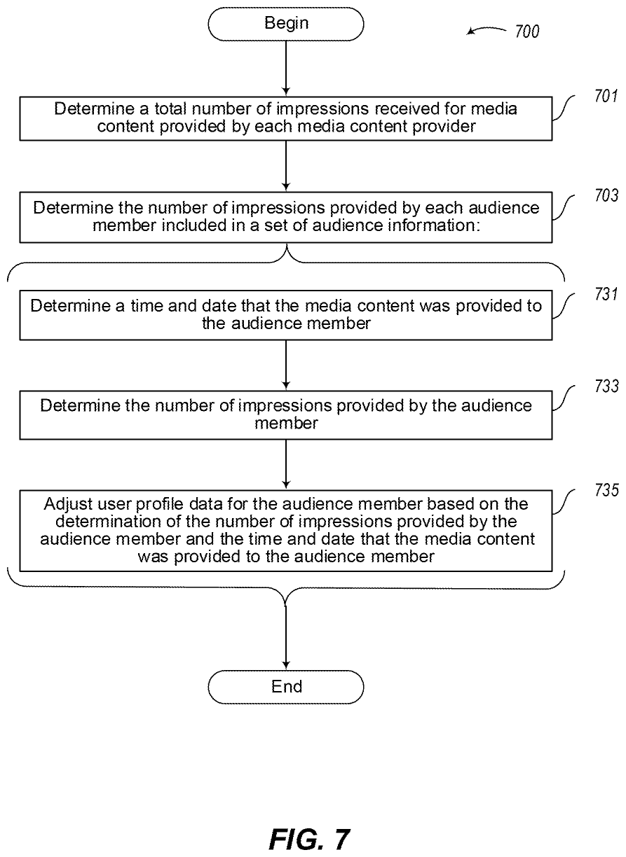

FIG. 7 is a flow diagram of a process 700 for determining an inventory ratio for each audience member, according to one illustrated implementation. The process 700 begins, after a start block, at act 701, where an advanced targeting system determines a total number of impressions received for media content provided by each media content provider. In some embodiments, the advanced targeting system determines the total number of impressions received for media content within a selected time period, such as the total number of impressions received over a day, week, month, etc. In some embodiments, the advanced targeting system determines the total number of impressions received for media content based on historical media content provider impression data. The historical media content provider impression data may be received from one or more media content providers, one or more systems for placing advertisements within advertisement placement opportunities, or other sources of data describing the amount of impressions received by media content.

The process 700 proceeds to act 703, where the advanced targeting system determines the number of impressions provided by each audience member included in a set of audience information. The advanced targeting system may perform act 703 by performing acts 731-735 for each respective audience member.

At act 731, the advanced targeting system determines a time and data that the media content was provided to the audience member. The advanced targeting system may perform act 731 based on one or more of: data received from the media content provider regarding the media content, historical media content provider impression data, and audience member historical impression data for the respective audience member.

At act 733, the advanced targeting system determines the number of impressions provided by the respective audience member. The advanced targeting system may determine the number of impressions provided by the respective audience member based on audience member historical impression data. The

At act 735, the advanced targeting system adjusts the user profile data for the respective audience member based on the determination of the number of impressions provided by the audience member and the time and date that the media content was provided to the audience member. In some embodiments, the advanced targeting system stores the adjusted user profile data in a user profile table, such as the user inventory profile table 300. In some embodiments, as part of performing act 735, the advanced targeting system determines an inventory ratio for the number of impressions provided by the audience member at the time and date that the media content was provided.

After act 735, the process 700 ends.

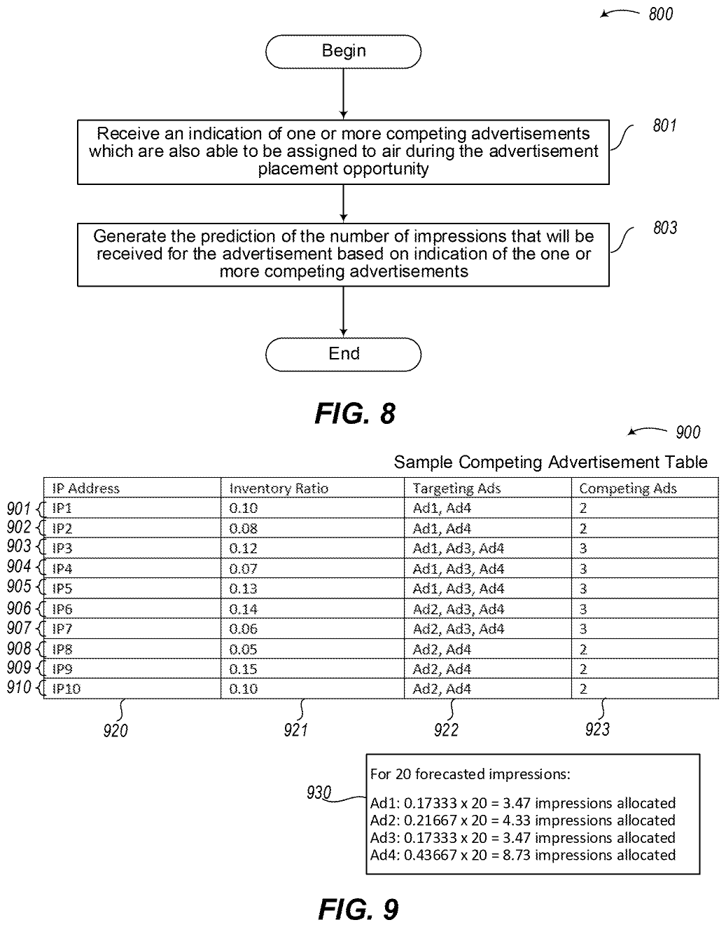

FIG. 8 is a flow diagram of a process 800 for generating prediction of the number of impressions that will be received for an advertisement based on an indication of one or more competing advertisements, according to one illustrated implementation. The process 800 begins, after a start block, at act 801, where an advanced targeting system receives an indication of one or more competing advertisements which are also able to be assigned to air during the advertisement placement opportunity. The advanced targeting system may receive the indication of the one or more competing advertisements from one or more advertisers, such as through an advertiser facing interface 103, from one or more systems used to place advertisements, or from another computing device or entity which may indicate when competing advertisements are to air.

The process 800 continues to act 803, where the advanced targeting system generates the prediction of the number of impressions that will be received for the advertisement based on the indication of the one or more competing advertisements and a generated impression prediction model. In some embodiments, at act 803, the advanced targeting system may determine which of the competing advertisements are to be targeted to audience members and which of the competing advertisements are not to be targeted to audience members. The advanced targeting system may determine which audience members are likely to see the competing advertisements in a similar manner to the process of determining the number of impressions allocated to targeted advertisements described in act 413, described above in connection with FIG. 4. The advanced targeting system may then combine this data for the advertisement and for each of the competing advertisements to predict the number of impressions received for the advertisement. An example of how the advanced targeting system and impression prediction model predict the number of impressions for competing advertisements is described below in connection with FIG. 9.

After act 803, the process 800 ends.

In some embodiments, when performing the process 800, the advanced targeting system takes into account “compete codes” for the advertisement or for each competing advertisement. A compete code may indicate one or more rules for placing advertisements, such as rules which may prevent the placement of advertisements of a certain type together. For example, the advertisement and a competing advertisement may have compete codes which indicate that the advertisements should not be placed in the same ad break. As an example, the advertisement and competing advertisement may be advertisements for different car dealerships, and may request that other car dealership advertisements are not placed within the same ad break. The advanced targeting system may use the compete codes to assist in determining which audience members are likely to see the advertisement and to predict the number of impressions each advertisement may receive.

In some embodiments, when performing the process 800, the advanced targeting system takes into account “frequency caps” for the advertisement or for each competing advertisement. A frequency cap may indicate one or more limits regarding how often an advertisement is shown to an audience member. For example, a frequency cap may indicate that an advertisement is not to be shown to an audience member more than twice per hour. The advanced targeting system may use the frequency caps to assist in determining which audience members are likely to see the advertisement, and to predict the number of impressions each advertisement may receive.

In some embodiments, when performing the process 800, the advanced targeting system takes into account one or more priority measures for the advertisement and for each competing advertisement. The priority measure may indicate the priority of placing the advertisement as compared to other advertisements, such that advertisements with high priority are more likely to be shown to an audience member than advertisements with low priority. The advanced targeting system may use the priority measures to assist in determining which audience members are likely to see the advertisement, and to predict the number of impressions each advertisement may receive.

FIG. 9 is a sample competing advertisement table 900, according to one illustrated implementation. The sample competing advertisement table 900 includes sample data that is in human-readable form and implementations of the advanced targeting system may include data in other forms. Additionally, the sample competing advertisement table 900 is non-exhaustive, and implementations of the advanced targeting system may include additional rows, columns, etc., which are not shown in FIG. 9. Furthermore, the sample competing advertisement table 900 is provided as an example, and some implementations of the advanced targeting system may not include a sample competing advertisement table.

The sample competing advertisement table 900 includes an IP address column 920, an inventory ratio column 921, a targeting ads column 922, and a competing ads column 923. The IP address column 920 includes information identifying an IP or other network address of a device associated with a particular audience member. The inventory ratio column 921 includes information indicating the inventory ratio for a particular audience member. The targeting ads column 922 includes information indicating the ads which are likely to be shown to the audience member, such as because they target a user segment the audience member belongs to, because they target every audience member, etc. The competing ads column 923 includes information indicating the number of ads which are competing for impressions from the audience member.

The sample competing advertisement table 900 additionally includes rows 901-910, which each correspond to a device associated with an audience member. The forecasted impressions 930 indicates the total number of impressions allocated to each advertisements which are provided by the audience members indicated in rows 901-910.

For example, to calculate the impressions allocated to “Ad1,” the advanced targeting system identifies which audience members may see the advertisement based on the targeting criteria. As seen in the sample competing advertisement table 900, in this example the audience members associated with rows 901-905 may see the advertisement. Furthermore, the sample competing advertisement table 900 shows that the audience members of rows 901 and 902 have two competing advertisements (“Ad1” and “Ad4”) while the audience members of rows 903-905 have 3 competing ads (“Ad1,” “Ad3,” and “Ad4”). In this example, the impression prediction model determines how much of each audience member's inventory ratio may be applied to each advertisement based on the total inventory ratio offered by the audience member and the competing advertisements for the audience member. Thus, the inventory ratio received by “Ad1” for the audience member of row 901 may be 0.05 (or 0.10 divided by 2 competing advertisements), while the inventory ratio received for audience member 903 would be 0.04. The inventory ratio received by “Ad1” is aggregated for each audience member which may see “Ad1” and then applied to the total number of impressions available to predict how many impressions “Ad1” may receive.

In this example, “Ad1” receives 0.05 inventory from the audience member of row 901, 0.04 inventory from the audience member of row 902, 0.04 inventory from the audience member of row 903, 0.0233 inventory from the audience member of row 904, and 0.0433 from the audience member of row 905, for a total inventory ratio of 0.17333, as indicated in the forecasted impressions 930. When this is applied to the 20 total impressions available, the impression prediction model predicts that “Ad1” may receive 3.47 impressions.

Furthermore, this example includes an advertisement, “Ad4,” which does not have any targeting criteria. Thus, for “Ad4,” the amount of the inventory received is 0.43667 because every audience member may see “Ad4” and “Ad4” competes with other advertisements for each audience member. As indicated in the forecasted impressions 930, “Ad4” is predicted to receive 8.73 impressions.

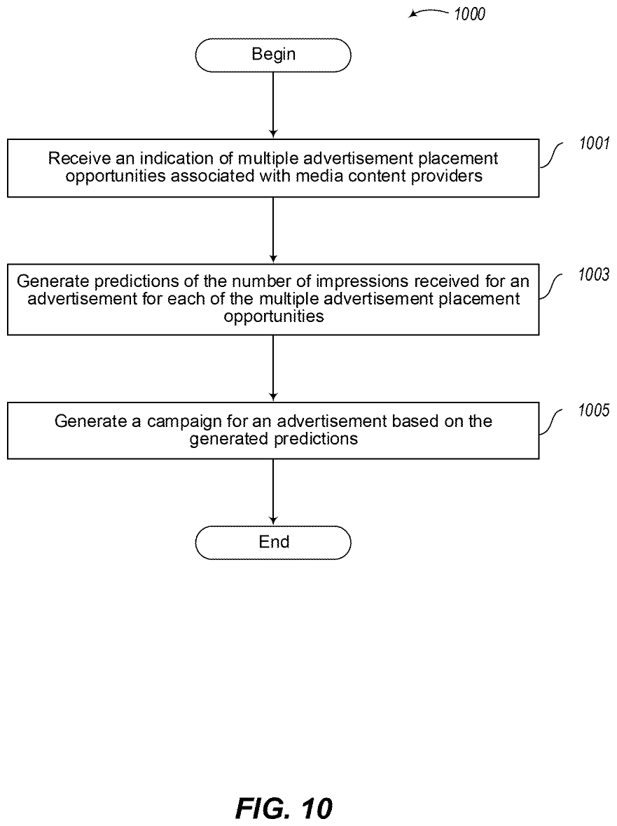

FIG. 10 is a flow diagram of a process 1000 for generating a campaign for an advertisement, according to one illustrated implementation. The process 1000 begins, after a start block, at act 1001, where the advanced targeting system receives an indication of multiple advertisement placement opportunities associated with media content providers. The advanced targeting system may receive the indication of multiple advertisement placement opportunities via one or more provider facing interfaces 105.

The process 1000 proceeds to act 1003, where the advanced targeting system generates predictions of the number of impressions received for an advertisement at each of the multiple advertisement placement opportunities. The advanced targeting system may perform act 1003 by using the process 400, the process 800, or another process used by the advanced targeting system to obtain a prediction of the number of impressions received for an advertisement at an advertisement placement opportunity from an impression prediction model.

The process 1000 proceeds to act 1005, where the advanced targeting system generates a campaign for an advertisement based on the generated predictions. In some embodiments, the advanced targeting system generates the campaign based on one or more goals received from a buyer associated with the advertisement, such as through an AFI 103. For example, the buyer may specify that they wish to receive a certain number of impressions from audience members which belong to one or more user segments. The advanced targeting system may identify which advertisement placement opportunities are able to provide those impressions based on the predictions generated in act 1003, and may generate the campaign based on the identified advertisement placement opportunities.

After act 1005, the process 1000 ends.

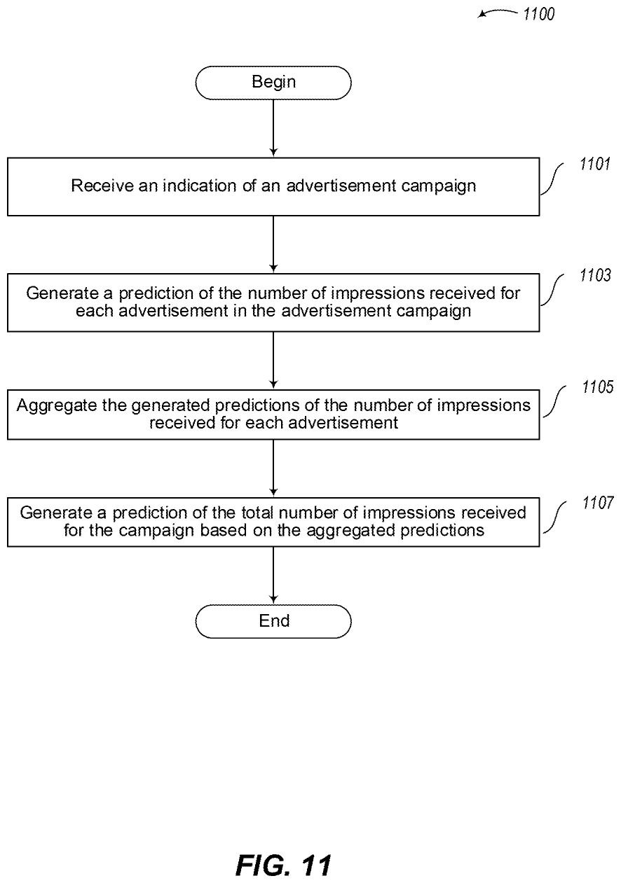

FIG. 11 is a flow diagram of a process 1100 to predict the number of impressions received by a campaign, according to one illustrated implementation. The process 1100 begins, after a start block, at act 1101, where the advanced targeting system receives an indication of an advertisement campaign. The indication of the advertisement campaign may include an indication of one or more advertisements included in the campaign, an indication of targeting criteria for each advertisement included in the campaign, an indication of the advertisement placement opportunities at which the advertisements are assigned, or other information related to an advertisement campaign. The advanced targeting system may receive the indication of the advertisement campaign through one or more provider facing interfaces 103.

The process 1100 proceeds to act 1103, where the advanced targeting system generates a prediction of the number of impression received for each advertisement in the advertisement campaign. The advanced targeting system may perform act 1103 by using the process 400, the process 800, or another process used by the advanced targeting system to obtain a prediction of the number of impressions received for an advertisement.

The process 1100 proceeds to act 1105, where the advanced targeting system aggregates the generated prediction of the number of impressions received for each advertisement included in the advertisement campaign. The process 1100 proceeds to act 1107, where the advanced targeting system generates a prediction of the total number of impression received for the campaign based on the aggregated predictions.

After act 1107, the process 1100 ends.

In some embodiments, the advanced targeting system generates potential augmentations to the advertisement campaign based on the predictions generated in act 1107. For example, the advanced targeting system may receive an indication of additional advertisement placement opportunities to which the advertisements included in the advertisement campaign may be assigned. The advanced targeting system may generate additional predictions for the number of impressions received by advertisements included in the advertisement campaign if they were to be placed in the additional advertisement placement opportunities. The advanced targeting system may generate suggested augmentations to the advertisement campaign based on one or more of the additional predictions and goals for the advertisement campaign.

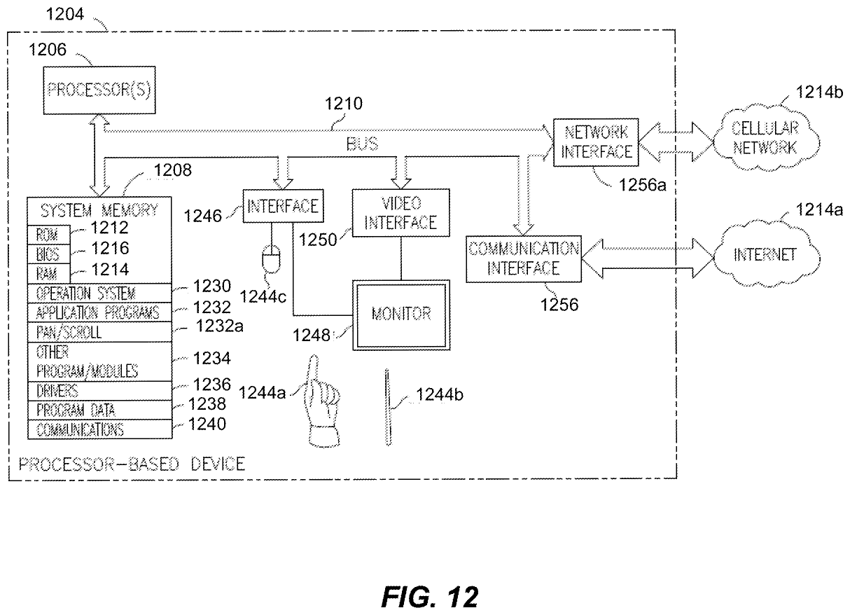

FIG. 12 shows a processor-based device 1204 suitable for implementing the various functionality described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1204 may include one or more processors 1206, a system memory 1208 and a system bus 1210 that couples various system components including the system memory 1208 to the processor(s) 1206. The processor-based device 1204 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1206 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 12 are of conventional design. As a result, such blocks need not be described in further detail herein, as they will be understood by those skilled in the relevant art.

The system bus 1210 can employ any known bus structures or architectures, including a memory bus with memory controller, a peripheral bus, and a local bus. The system memory 1208 includes read-only memory (“ROM”) 1212 and random access memory (“RAM”) 1214. A basic input/output system (“BIOS”) 1216, which can form part of the ROM 1212, contains basic routines that help transfer information between elements within processor-based device 1204, such as during start-up. Some implementations may employ separate buses for data, instructions and power.

The processor-based device 1204 may also include one or more solid state memories, for instance Flash memory or solid state drive (SSD) 1218, which provides nonvolatile storage of computer-readable instructions, data structures, program modules and other data for the processor-based device 1204. Although not depicted, the processor-based device 1204 can employ other nontransitory computer- or processor-readable media, for example a hard disk drive, an optical disk drive, or memory card media drive.

Program modules can be stored in the system memory 1208, such as an operating system 1230, one or more application programs 1232, other programs or modules 1234, drivers 1236 and program data 1238.

The application programs 1232 may, for example, include panning/scrolling 1232a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1232a may, for example, be stored as one or more executable instructions. The panning/scrolling logic 1232a may include processor and/or machine executable logic or instructions to generate user interface objects using data that characterizes movement of a pointer, for example data from a touch-sensitive display or from a computer mouse or trackball, or other user interface device.

The system memory 1208 may also include communications programs 1240, for example a server and/or a Web client or browser for permitting the processor-based device 1204 to access and exchange data with other systems such as user computing systems, Web sites on the Internet, corporate intranets, or other networks as described below. The communications programs 1240 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 12 as being stored in the system memory 1208, the operating system 1230, application programs 1232, other programs/modules 1234, drivers 1236, program data 1238 and server and/or browser 1240 can be stored on any other of a large variety of nontransitory processor-readable media (e.g., hard disk drive, optical disk drive, SSD and/or flash memory).

A user can enter commands and information via a pointer, for example through input devices such as a touch screen 1248 via a finger 1244a, stylus 1244b, or via a computer mouse or trackball 1244c which controls a cursor. Other input devices can include a microphone, joystick, game pad, tablet, scanner, biometric scanning device, etc. These and other input devices (i.e., “I/O devices”) are connected to the processor(s) 1206 through an interface 1246 such as touch-screen controller and/or a universal serial bus (“USB”) interface that couples user input to the system bus 1210, although other interfaces such as a parallel port, a game port or a wireless interface or a serial port may be used. The touch screen 1248 can be coupled to the system bus 1210 via a video interface 1250, such as a video adapter to receive image data or image information for display via the touch screen 1248. Although not shown, the processor-based device 1204 can include other output devices, such as speakers, vibrator, haptic actuator, etc.

The processor-based device 1204 may operate in a networked environment using one or more of the logical connections to communicate with one or more remote computers, servers and/or devices via one or more communications channels, for example, one or more networks 1214a, 1214b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1204 may include one or more wired or wireless communications interfaces 1214a, 1214b (e.g., cellular radios, WI-FI radios, Bluetooth radios) for establishing communications over the network, for instance the Internet 1214a or cellular network.

In a networked environment, program modules, application programs, or data, or portions thereof, can be stored in a server computing system (not shown). Those skilled in the relevant art will recognize that the network connections shown in FIG. 12 are only some examples of ways of establishing communications between computers, and other connections may be used, including wirelessly.

For convenience, the processor(s) 1206, system memory 1208, network and communications interfaces 1214a, 1214b are illustrated as communicably coupled to each other via the system bus 1210, thereby providing connectivity between the above-described components. In alternative implementations of the processor-based device 1204, the above-described components may be communicably coupled in a different manner than illustrated in FIG. 12. For example, one or more of the above-described components may be directly coupled to other components, or may be coupled to each other, via intermediary components (not shown). In some implementations, system bus 1210 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a computer system, comprising:
receiving a plurality of sets of audience information from a plurality of audience information providers, each set of audience information including information describing a plurality of audience members, wherein information describing at least a portion of the audience members appears in at least two sets of the plurality of sets of audience information;
identifying a plurality of user segments used by each audience information provider of the plurality of audience information providers;
receiving audience member historical impression data for each audience member included in each set of audience information of the plurality of sets of audience information;
receiving historical media content provider impression data for each media content provider of a plurality of media content providers, the historical media content provider impression data including data indicating a number of impressions received for media content provided by the media content provider;
generating, based on at least the plurality of sets of audience information, the plurality of user segments, the audience member historical impression data, and the historical media content provider impression data, an impression prediction model operative to predict the number of impressions which will be received for an advertisement;
receiving an indication of an advertisement which is able to be assigned to air during a particular advertisement placement opportunity associated with a media content provider of the plurality of media content providers, the indication of the advertisement including an indication of the total number of impressions available for the advertisement and targeting criteria for the advertisement; and
generating a prediction of the number of impressions that will be received for the advertisement based on the indication of the advertisement and the generated impression prediction model.

2. The method of claim 1, wherein generating the impression prediction model further comprises:
for each respective audience member included in the plurality of sets of audience information, identifying user profile data by:
identifying, based on the audience member historical impression data and the information describing the respective audience member, an indication of:
at least one network address associated with a computing device associated with the respective audience member;
at least one media content provider which provided media content to the computing device associated with the respective audience member;
at least one time that the at least one media content provider provided media content; and
for each time that the at least one media content provider provided media content, a number of impressions; and
generating, based on the identified user profile data, a user profile data table.

3. The method of claim 2, wherein generating the user profile data table further comprises:
aggregating the user segments of the plurality of user segments to generate a plurality of aggregated user segments; and
for each respective audience member included in the plurality of sets of audience information:
determining which user segments of the plurality of aggregated user segments apply to the respective audience member; and
adjusting the user profile data for the respective audience member based on the determination of which user segments apply to the respective audience member.

4. The method of claim 2, wherein generating the user profile data table further comprises:
determining, based on the historical media content provider impression data, a total number of impressions received for media content provided by each media content provider of the plurality of media content providers; and
for each respective audience member included in the plurality of sets of audience information:
determining a time of day that the media content was provided to the audience member;
determining a time period within which the media content was provided to the audience member;
determining a respective media content provider which provided the media content to the audience member;
determining, based on the time of day, the time period, the media content provider, and the total number of impressions, the number of impressions provided by the audience member; and
adjusting the user profile data for the audience member based on the determination of the number of impressions provided by the audience member.

5. The method of claim 4, wherein generating the prediction further comprises:
receiving an indication of one or more competing advertisements which are also able to be assigned to air during the advertisement placement opportunity, the indication of one or more competing advertisements including targeting criteria for each competing advertisement; and
generating the prediction of the number of impressions that will be received for the advertisement based on the indication of the advertisement, the generated impression prediction model, the user profile table, and the indication of the one or more competing advertisements.

6. The method of claim 1, wherein each user segment comprises an indication that one or more users share similar attributes, wherein the attributes include at least one of:
an age of the user;
an occupation of the user;
an income level of the user; or
an indication of behavioral information regarding the user.

7. The method of claim 1, further comprising:
assigning the advertisement to an advertisement placement opportunity based on the predicted number of impressions for the advertisement.

8. The method of claim 1, wherein the media content provider impression data further includes information indicating at least one date and at least one time that impressions are received for the media content provided by the media content provider.

9. The method of claim 1, wherein generating the prediction of the number of impressions further comprises:
receiving an indication of one or more competing advertisements which are also able to be assigned to air during the time that the advertisement placement opportunity occurs, the indication of one or more competing advertisements including targeting criteria for each competing advertisement; and
generating the prediction of the number of impressions received for the advertisement based on the indication of the advertisement, the generated impression prediction model and the indication of the one or more competing advertisements.

10. The method of claim 9, wherein the indication of one or more competing advertisements further includes one or more compete codes for each competing advertisement.

11. The method of claim 9, wherein the indication of one or more competing advertisements further includes one or more frequency caps for each competing advertisement.

12. The method of claim 9, wherein the indication of the advertisement includes a priority measure for the advertisement, the indication of the one or more competing advertisements further includes one or more priority measures for each competing advertisement, and generating the prediction further comprises:
determining which competing advertisements of the one or more competing advertisements have a priority measure which is the same as the priority measure for the advertisement; and
based on the determining, generating the prediction of the number of impressions received for the advertisement based on the indication of the advertisement, the generated impression prediction model, and the determined competing advertisements which have a have a priority measure which is the same as the priority measure for the advertisement.

13. The method of claim 1, wherein the method further comprises:
receiving an indication of one or more additional advertisement placement opportunities associated with one or more media content providers of the plurality of media content providers;
generating additional predictions of the number of impressions received for the advertisement for each of the one or more additional advertisement placement opportunities based on the indication of the advertisement, the generated impression prediction model, and the indication of the one or more additional advertisement placement opportunities; and
based on at least the prediction of the number of impression received for the advertisement and the additional predictions of the number of impressions received for the advertisement, augmenting one or more parameters of a campaign for the advertisement.

14. The method of claim 1, wherein the method further comprises:
receiving an indication of an advertisement campaign, the indication of the advertisement campaign including an indication of a plurality of advertisements, each respective advertisement of the plurality of advertisements being assigned to an advertisement placement opportunity, each respective advertisement further including targeting criteria for the respective advertisement, wherein the plurality of advertisements includes the advertisement; and
for each respective advertisement included in the advertisement campaign:
generating an additional prediction of the number of impressions that will be received for the advertisement based on the indication of the respective advertisement, and the generated impression prediction model for the respective advertisement.

15. The method of claim 14, wherein the method further comprises:
aggregating the predictions of the number of impressions received for each respective advertisement in the advertisement campaign; and
generating a prediction of the total number of impression that will be received for the advertisement campaign based on the aggregated predictions.

16. The method of claim 1, wherein the targeting criteria includes at least one of:
one or more media content providers; or
one or more dayparts.

17. The method of claim 1, wherein generating the prediction of the number of impressions that will be received for the advertisement is performed in near-real-time.

18. A system, comprising:
at least one processor; and
at least one memory coupled to the at least one processor, the at least one memory having computer-executable instructions stored thereon that, when executed by the at least one processor, cause the system to:
receive a plurality of sets of audience information from a plurality of audience information providers, each set of audience information including information describing a plurality of audience members, wherein information describing at least a portion of the audience members appears in at least two sets of the plurality of sets of audience information;
identify a plurality of user segments used by each audience information provider of the plurality of audience information providers;
receive audience member historical impression data for each audience member included in each set of audience information of the plurality of sets of audience information;
receive historical media content provider impression data for each media content provider of a plurality of media content providers, the historical media content provider impression data including data indicating a number of impressions received for media content provided by the media content provider;
generate, based on at least the plurality of sets of audience information, the plurality of user segments, the audience member historical impression data, and the historical media content provider data, an impression prediction model operative to predict the number of impressions which will be received for an advertisement;
receive an indication of an advertisement which is able to be assigned to air during a particular advertisement placement opportunity associated with a media content provider of the plurality of media content providers, the indication of the advertisement including an indication of the total number of impressions available for the advertisement and targeting criteria for the advertisement; and
generate a prediction of the number of impressions that will be received for the advertisement based on the indication of the advertisement, and the generated impression prediction model.

19. A nontransitory processor-readable storage medium that stores at least one of instructions or data, the instructions or data, when executed by at least one processor, cause the at least one processor to:
receive a plurality of sets of audience information from a plurality of audience information providers, each set of audience information including information describing a plurality of audience members, wherein information describing at least a portion of the audience members appears in at least two sets of the plurality of sets of audience information;
identify a plurality of user segments used by each audience information provider of the plurality of audience information providers;
receive audience member historical impression data for each audience member included in each set of audience information of the plurality of sets of audience information;
receive historical media content provider impression data for each media content provider of a plurality of media content providers, the historical media content provider impression data including data indicating a number of impressions received for media content provided by the media content provider;
generate, based on at least the plurality of sets of audience information, the plurality of user segments, the audience member historical impression data, and the historical media content provider data, an impression prediction model operative to predict the number of impressions which will be received for an advertisement;
receive an indication of an advertisement which is able to be assigned to air during a particular advertisement placement opportunity associated with a media content provider of the plurality of media content providers, the indication of the advertisement including an indication of the total number of impressions available for the advertisement and targeting criteria for the advertisement; and
generate a prediction of the number of impressions that will be received for the advertisement based on the indication of the advertisement, and the generated impression prediction model.
